(19) United States
(12) Patent Application Publication
(10) Pub. No.: US 2003/0119553 A1
(43) Pub. Date: Jun. 26, 2003

(54) Transmission apparatus for cellulous phone

(75) Inventor: Hui Chang Chuang, Pan Chiao City (TW)

Correspondence Address: BROWDY AND NEIMARK, P.L.L.C., 624 NINTH STREET, NW, SUITE 300, WASHINGTON, DC, 20001-5303, US

(73) Assignee: Sinbon Electronics Company Ltd., Miaoli City (TW)

(21) Appl. No.: 10/255,945

(22) Filed: Sep. 27, 2002

(30) Foreign Application Priority Data
Dec. 26, 2001 (TW) 90222837

(51) Int. Cl. H04B 1/38

(52) U.S. Cl. 455/557; 455/559

(57) ABSTRACT

A transmission apparatus for cellulous phone comprises a first connector, a conversion module and a second connector. The first connector is connected to a USB port of a computer and receives a charging signal and a data signal. The conversion module is connected to the first connector and converts the data signal and the charging signal from the first connector into signal accessible to the cellulous phone. The second connector is connected to the conversion module and transmits the serial data and the charging voltage to the cellulous phone connected to the second connector. The transmission apparatus can facilitate the cellulous phone and the computer to simultaneously perform charging battery, accessing wireless network and interchanging data operations.

### FIELD OF THE INVENTION

The present invention relates to a transmission apparatus for cellulous phone, especially to a transmission apparatus for cellulous phone to perform charging battery, accessing wireless network and interchanging data functions.

### BACKGROUND OF THE INVENTION

The mobile communication technique provides new aspects to economics and communication ways for people. The notebook computer can be plugged to wireless network through cellulous phone and transmit data with other wireless access points.

However, the cellulous phone generally has the problem of short standby time and requires frequent charging operation. One solution to this problem is to charge the cellulous phone with the notebook computer. As shown in FIG. 1, a conventional cellulous phone 3a can be charged by a notebook computer 1a through a charging cord 2a, wherein the charging cord 2a is connected between a USB (universal serial bus) port 11a of the notebook computer 1a and a signal socket (not shown) of the cellulous phone 3a. Therefore, the battery of the cellulous phone 3a can be charged by electric power output through the USB port 11a of the notebook computer 1a.

FIG. 2 depicts the wireless data transmission application of conventional cellulous phone for notebook computer. More particularly, the signal socket (not shown) of the cellulous phone 3a is connected to the COM port 12a of the notebook computer 1a through a data cord 4a. Therefore, the notebook computer 1a can access wireless network or the data of the cellulous phone 3a can be updated.

However, in above-described charging and data transmission schemes, the cellulous phone 3a uses different cords (charging cord 2a and data cord 4a) connected to the notebook computer 1a. Therefore, the cellulous phone 3a cannot simultaneously perform wireless data accessing and charging functions. That is, the cellulous phone 3a cannot perform wireless data accessing during charging and cannot perform charging function during wireless data accessing operation. Moreover, the user should carry both charging cord 2a and data cord 4a for charging and data transmission operations. The cost of the cellulous phone 3a is increased.

### SUMMARY OF THE INVENTION

It is an object of the present invention to provide a transmission apparatus for cellulous phone to simultaneously perform charging battery, accessing wireless network and interchanging data functions in conjunction with a notebook computer.

It is another object of the present invention to provide a transmission apparatus for cellulous phone to simultaneously perform charging battery, accessing wireless network and interchanging data functions by a single transmission cord to reduce cost.

It is still another object of the present invention to provide a plug-and-play transmission apparatus for cellulous phone.

To achieve above object, the present invention provides a transmission apparatus for cellulous phone and bridging between a computer and a cellulous phone. The transmission apparatus for cellulous phone comprises a first connector, a conversion module and a second connector. The first connector is connected to a USB port of a computer and receives a charging signal and a data signal. The conversion module is connected to the first connector and converts the data signal and the charging signal from the first connector into signal accessible to the cellulous phone. The second connector is connected to the conversion module and transmits the serial data and the charging voltage to the cellulous phone connected to the second connector. The transmission apparatus can facilitate the cellulous phone and the computer to simultaneously perform charging battery, accessing wireless network and interchanging data operations

The various objects and advantages of the present invention will be more readily understood from the following detailed description when read in conjunction with the appended drawing, in which:

### BRIEF DESCRIPTION OF DRAWINGS

FIG. 1 shows a conventional cellulous phone charged by a notebook computer through a charging cord;

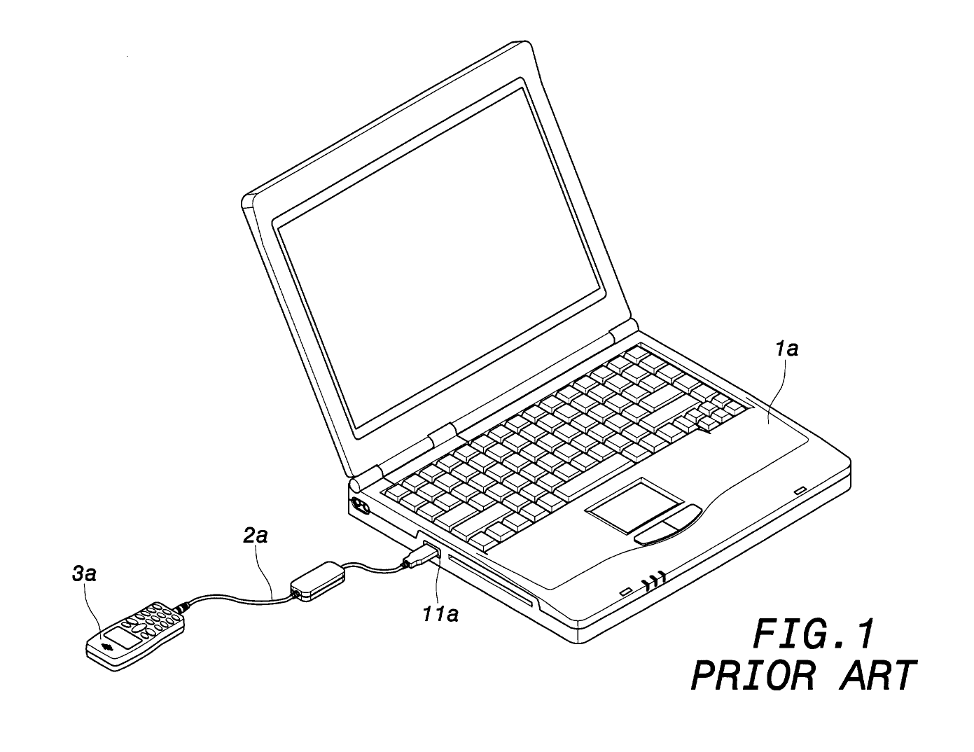

FIG. 2 shows a conventional cellulous phone communicated with a notebook computer through a data cord;

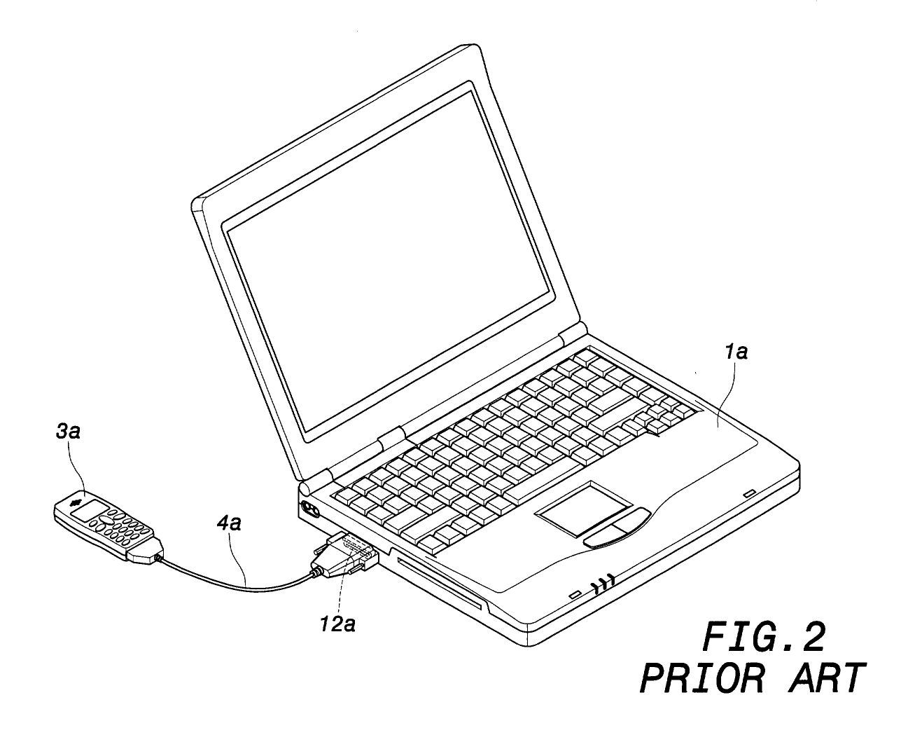

FIG. 3 shows a perspective view of the transmission apparatus for cellulous phone according to the present invention;

FIG. 4 shows a perspective view of the transmission apparatus for cellulous phone connected between a cellulous phone and a notebook computer;

FIG. 5 shows a block diagram of the conversion module of the present invention; and

FIG. 6 shows a circuit diagram of the conversion module of the present invention.

### DETAILED DESCRIPTION OF THE INVENTION

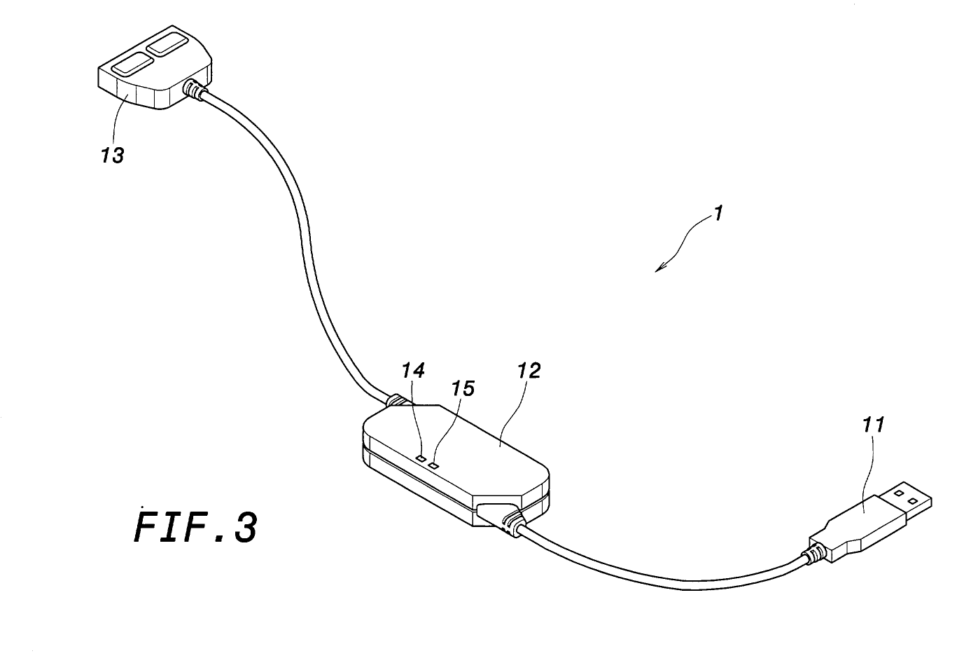

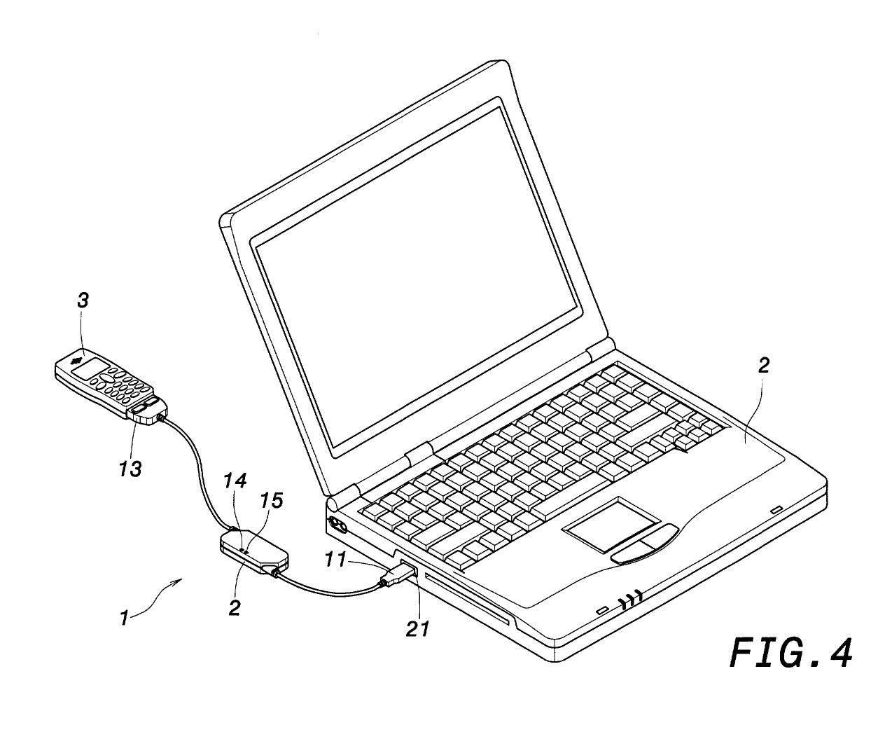

FIGS. 3 and 4 show the perspective view of the transmission apparatus for cellulous phone according to the present invention and the perspective view of the transmission apparatus connected between a cellulous phone 3 and a notebook computer 1. The transmission apparatus 1 can simultaneously perform charging battery, accessing wireless network and interchanging data functions for the cellulous phone. The inventive transmission apparatus 1 comprises a first connector 11, a conversion module 12 and a second connector 13.

The first connector 11 is a USB connector with an input compatible to a USB port 21 of a notebook computer. Therefore, the first connector 11 has plug-and-play function and can transmit both charging signal and data signal. The conversion module 12 is connected to an output of the first connector 11 and converts the data signal from the first connector 11 into a serial data and converts the charging signal from the first connector 11 into a charging voltage. Moreover, the conversion module 12 has a data indication lamp 14 for indicating serial data transmission operation and a charging indication lamp 15 for indicating charging operation. The second connector 13 is connected to an output of the conversion module 12. The second connector 13 receives the serial data and the charging voltage and transmits the serial data and the charging voltage to the cellulous phone 3 connected to the second connector 13.

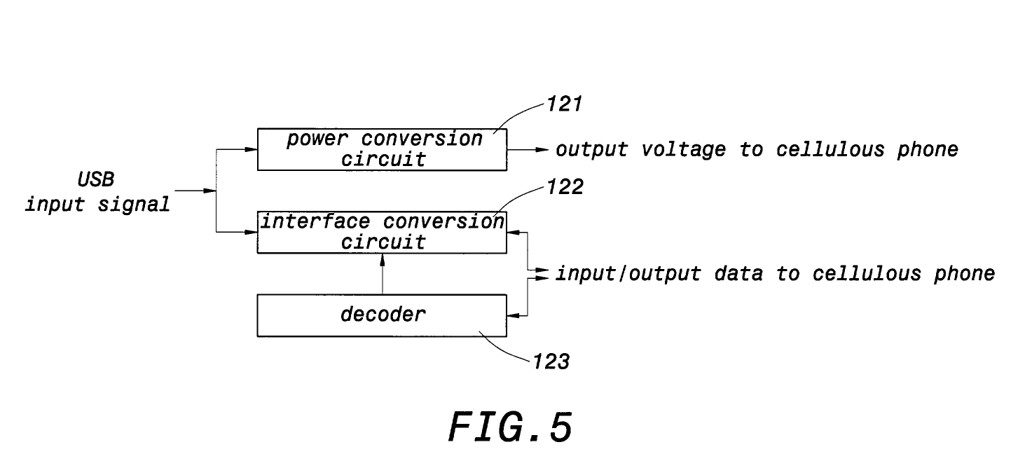

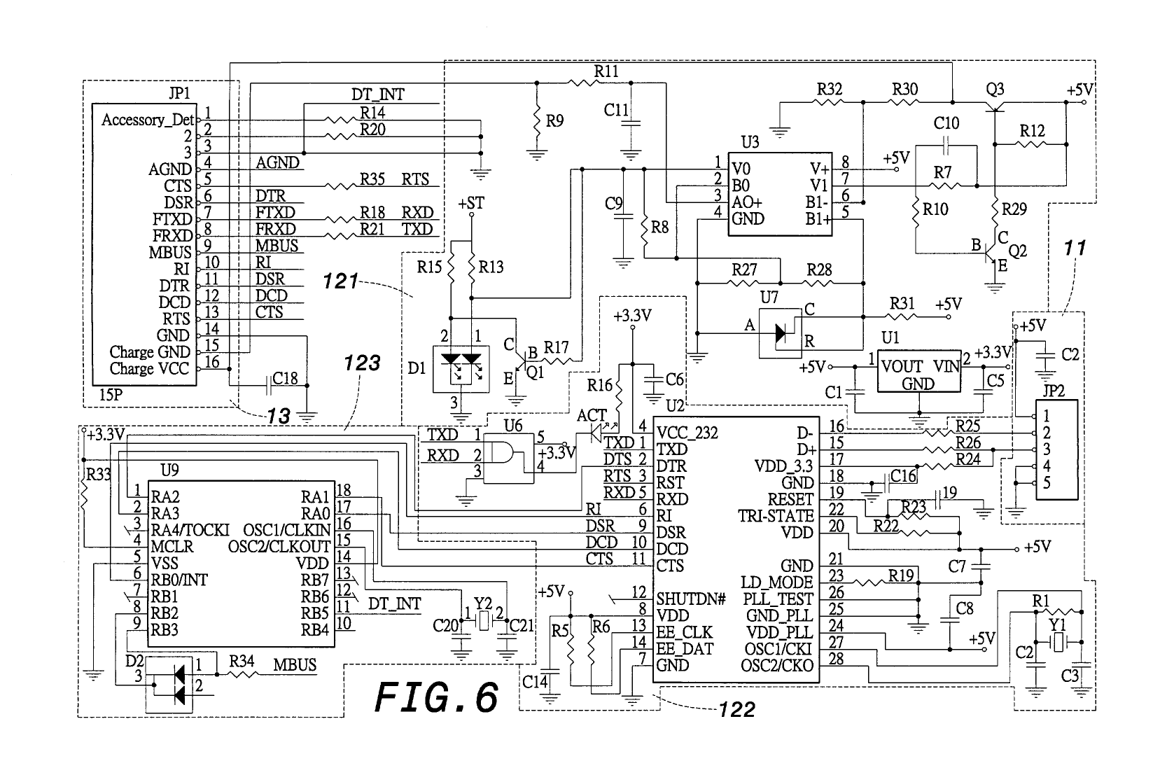

FIG. 5 shows the block diagram of the conversion module 12 and FIG. 6 shows the circuit diagram of the conversion module 12. The conversion module 12 is composed of a power conversion circuit 121, an interface conversion circuit 122 and a decoder 123. The power conversion circuit 121 is composed of power controller chip U1, U3, transistor Q1, Q2, capacitors C9-C11 and other components. The power conversion circuit 121 converts the charging signal from the USB interface into a charging voltage and regulates the charging voltage such that the cellulous phone 3 has stable charging voltage. Moreover, the power conversion circuit 121 provides electric power to the interface conversion circuit 122. The interface conversion circuit 122 is composed of a controller chip U2, resistors R22-R26 and other components. The interface conversion circuit 122 converts the data signal from the USB interface into a serial data accessible to the cellulous phone 3. The decoder 123 is composed of a decoding chip U9, capacitors C20, C21 and other components. The decoder 123 decodes a handshaking signal from the serial data and associated with network interlink function. The decoded handshaking signal is sent to the interface conversion circuit 122 to facilitate the cellulous phone 3 for accessing wireless network and sending/receiving fax.

To sum up, the transmission apparatus for cellulous phone according to the present invention has following advantages:

(1) The cellulous phone used with the notebook computer can simultaneously perform charging battery, accessing wireless network and interchanging data functions by the transmission apparatus.

(2) The transmission apparatus has plug and play feature.

(3) Cost reduction and simplified components.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A transmission apparatus for cellulous phone and bridging between a computer and a cellulous phone, the transmission apparatus comprising:
a first connector connected to a USB port of the computer and receiving a charging signal and a data signal;
a conversion module connected to an output of the first connector and converting the data signal from the first connector into a serial data and converting the charging signal from the first connector into a charging voltage; and
a second connector connected to an output of the conversion module, the second connector receiving the serial data and the charging voltage and transmitting the serial data and the charging voltage to the cellulous phone connected to the second connector,
whereby the transmission apparatus can facilitate the cellulous phone and the computer to simultaneously perform charging battery, accessing wireless network and interchanging data operations.

2. The transmission apparatus for cellulous phone as in claim 1, wherein the computer can be one of the notebook computer, desktop computer and palm computer.

3. The transmission apparatus for cellulous phone as in claim 1, wherein the conversion module has a data indication lamp for indicating serial data transmission operation.

4. The transmission apparatus for cellulous phone as in claim 1, wherein the conversion module has a charging indication lamp for indicating charging operation.

5. The transmission apparatus for cellulous phone as in claim 1, wherein the conversion module comprises
a power conversion circuit used to convert the charging signal into a charging voltage and regulate the charging voltage;
an interface conversion circuit converting the data signal into the serial data accessible to the cellulous phone; and
a decoder decoding a handshaking signal from the serial data and associated with network interlink function and sending the decoded handshaking signal to the interface conversion circuit to facilitate the cellulous phone for accessing wireless network and sending/receiving fax.
